(19) United States
(12) Patent Application Publication
(10) Pub. No.: US 2014/0282327 A1
(43) Pub. Date: Sep. 18, 2014

(54) CUTTER IN DIAGNOSIS (CID) A METHOD TO IMPROVE THE THROUGHPUT OF THE YIELD RAMP UP PROCESS

(71) Applicant: NVIDIA CORPORATION, Santa Clara, CA (US)

(72) Inventors: Vishal Mehta, Milpitas, CA (US); Bruce Cory, Aptos, CA (US)

(73) Assignee: NVIDIA CORPORATION, Santa Clara, CA (US)

(21) Appl. No.: 13/830,683

(22) Filed: Mar. 14, 2013

(51) Int. Cl. G06F 17/50

(52) U.S. Cl. CPC G06F 17/5081
USPC 716/112; 716/136

(57) ABSTRACT

A method for producing candidate fault circuitry in an integrated circuit (IC) is disclosed. The method comprises tracing back from at least one failing output of the IC to determine a corresponding fan-in cone for each failing output using simulation values obtained from a fault free simulation of a design of the IC. Further, it comprises determining a first set of suspect fault candidates for each failing output, wherein each suspect fault candidate potentially corresponds to a defective element in the IC. Next, it comprises tracing forward from each suspect in the first set to determine a second set of suspects, which is a narrower subset of the first set. Finally, it comprises identifying a failing block from the IC design, wherein the failing block comprises suspect fault candidates from the second set and can be simulated independently of the full design.

### FIELD OF THE INVENTION

Embodiments according to the present invention generally relate to semiconductor integrated circuit (IC) production and more specifically to a method and system for improving the speed of the yield ramp up process during IC production.

### BACKGROUND OF THE INVENTION

Semiconductor IC production is an inherently complex flow, starting with the design of a new chip, through a stringent manufacturing process, and ending with product testing and distribution. The data analysis required to monitor and enhance yield is a significant challenge, especially as data volumes grow large and diverse with continually shrinking technology nodes. Product-specific design-process-test methodologies have further complicated the path to root cause diagnosis, making it more difficult for engineers to develop a clear understanding of the nature of yield limiters and, thereby, slowing down the speed of the yield ramp up process.

The speed of the yield ramp up process is critical to the time-to-market metric in the semiconductor industry. Determining the root cause of a failing behavior in the IC is the critical task in the yield ramp up process. Conventional software based root-causing methodologies tend to be extremely slow and resource intensive for large designs, e.g., a central processing unit (CPU) or a graphics processing unit (GPU). For example, it may take up to two days on a tester system with 256 Gigabytes (GB) of memory to determine the root cause of failure for one failing GPU chip. Accordingly, if a wafer comprising 100 chips has 50 chips that fail, it may take up to 100 days to determine root cause of failure for all the chips. This level of delay is unacceptable.

Purchasing several high capacity tester systems and running them in parallel does not provide an adequate solution. High capacity machines with over 256 GB of memory are expensive and the capital outlay required to acquire several such machines so they can be run in parallel is significant. Also, because the software based root-causing procedures simulate the entire design of the chip on these tester systems using test patterns provided by the design for test (DFT) engineers, they are extremely slow. One reason for the slowness is unnecessary simulation of the entire design when the defect causing the failure may constitute only a miniscule portion of the entire chip. For example, in a GPU comprising 150 million cells, only one cell may be affected a defect. Or, for example, a particle defect may affect only approximately 1-micrometer square of chip area while the entire chip may be more than 500 millimeters square. Conventional simulation software will, regardless, simulate the entire design even though diagnosis and simulation may only be necessary for a small set of cells in order to perform root cause analysis on the defect location.

### BRIEF SUMMARY OF THE INVENTION

Accordingly, what is needed is an efficient, speedy and inexpensive system and method for performing root cause analysis of failing chips that obviates the need to simulate the design for an entire chip if the defect causing the failure is localized to a relatively small area of the chip.

Embodiments of the present invention provide solutions to the challenges inherent in speeding the yield ramp up process. One embodiment of the present invention intelligently determines and carves out the logic affected by the defect from the entire design of the chip and creates a smaller design. Subsequently, the software based simulations are run on the smaller design in order to provide candidate circuitry for use in isolating the defect location. This method taught by the present invention can be referred to as “Cutter in Diagnosis (CID).”

In one embodiment, a method for producing candidate fault circuitry in an integrated circuit (IC) is disclosed. The method comprises tracing back from at least one failing output of the IC to determine a corresponding fan-in cone for each failing output using simulation values obtained from a fault free simulation of a design of the IC. Further, it comprises determining a first set of suspect fault candidates for each failing output, wherein each suspect fault candidate potentially corresponds to a defective element in the IC. Next, it comprises tracing forward from each suspect in the first set to determine a second set of suspects, which is a narrower subset of the first set. Finally, it comprises identifying a failing block from the IC design, wherein the failing block comprises suspect fault candidates from the second set and can be simulated independently of the full design.

In another embodiment, a computer-readable storage medium having stored thereon, computer executable instructions that, if executed by a computer system cause the computer system to perform a method for producing candidate fault circuitry in integrated circuits is disclosed. The method comprises tracing back from at least one failing output of the IC to determine a corresponding fan-in cone for each failing output using simulation values obtained from a fault free simulation of a design of the IC. Further, it comprises determining a first set of suspect fault candidates for each failing output, wherein each suspect fault candidate potentially corresponds to a defective element in the IC. Next, it comprises tracing forward from each suspect in the first set to determine a second set of suspects, which is a narrower subset of the first set. Finally, it comprises identifying a failing block from the IC design, wherein the failing block comprises suspect fault candidates from the second set and can be simulated independently of the full design.

In a different embodiment, a tester system is disclosed. The tester system comprises an input interface for reading in a test log, wherein the test log comprises information concerning observed responses recorded at a plurality of failing outputs during hardware testing and probing of a die. It also comprises a memory for storing a design of an integrated circuit corresponding to the die and simulation values generated from a simulation of the design of the integrated circuit. Further, it comprises a processor configured to: (a) trace back from the plurality of failing outputs associated with the design of the integrated circuit to determine a corresponding fan-in cone for each failing output using simulation values obtained from a fault free simulation of the design of the integrated circuit; (b) determine a first set of suspect fault candidates for the each failing output, wherein each suspect fault candidate potentially corresponds to a defect in the integrated circuit responsible for producing a failing result at a corresponding failing output; (c) trace forward from each suspect fault candidate in the first set to determine a second set of suspect fault candidates, wherein the second set is a narrower subset of the first set, and wherein each suspect fault candidate in the second set has a higher likelihood of corresponding to a defect in the integrated circuit than each suspect fault candidate in the first set; and (e) identify a failing block from the design of the integrated circuit, wherein the failing block comprises suspect fault candidates from the second set, and wherein the failing block can be simulated independently of the design.

The following detailed description together with the accompanying drawings will provide a better understanding of the nature and advantages of the present invention.

### BRIEF DESCRIPTION OF THE DRAWINGS

Embodiments of the present invention are illustrated by way of example, and not by way of limitation, in the figures of the accompanying drawings and in which like reference numerals refer to similar elements.

FIG. 1 is a block diagram of an example of a computing system capable of implementing embodiments of the present disclosure.

FIG. 2 is a schematic block diagram for an automated test equipment apparatus used to test semiconductor IC chips.

FIG. 3 illustrates an electron microscope image showing an exemplary open defect on metal.

FIG. 4 illustrates an exemplary failing block in the chip design comprising the logic affected by the defect that can be carved out using the Cutter In Diagnosis (CID) tool in accordance with one embodiment of the present invention.

FIG. 5A is a block diagram illustrating an exemplary process flow for a general diagnostic procedure used to cull the list of suspect faults to determine a failing block in the chip design in accordance with one embodiment of the present invention.

FIG. 5B is a block diagram illustrating the diagnostic partitioning used to determine the failing blocks associated with failing output bits in accordance with one embodiment of the present invention.

FIG. 6 is a block diagram illustrating an exemplary process flow for troubleshooting a defected IC, determining the root cause of failure using the CID tool, and improving yield in accordance with one embodiment of the present invention.

FIG. 7 depicts a flowchart 640 of an exemplary process of identifying candidate fault circuitry using the CID procedures according to an embodiment of the present invention.

### DETAILED DESCRIPTION OF THE INVENTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computer system. It has proven convenient at times, principally for reasons of common usage, to refer to these signals as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “determining,” “simulating,” “tracing,” “extracting,” or the like, refer to actions and processes (e.g., flowchart 640 of FIG. 7) of a computer system or similar electronic computing device or processor (e.g., system 110 of FIG. 1). The computer system or similar electronic computing device manipulates and transforms data represented as physical (electronic) quantities within the computer system memories, registers or other such information storage, transmission or display devices.

Embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer-readable storage media and communication media; non-transitory computer-readable media include all computer-readable media except for a transitory, propagating signal. Generally, program modules include routines, programs, objects, components, data structures, etc., that perform particular tasks or implement particular abstract data types. The functionality of the program modules may be combined or distributed as desired in various embodiments.

Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can accessed to retrieve that information.

Communication media can embody computer-executable instructions, data structures, and program modules, and includes any information delivery media. By way of example, and not limitation, communication media includes wired media such as a wired network or direct-wired connection, and wireless media such as acoustic, radio frequency (RF), infrared, and other wireless media. Combinations of any of the above can also be included within the scope of computer-readable media.

FIG. 1 is a block diagram of an example of a computing system 110 capable of implementing the Cutter In Diagnosis (CID) tool of the present disclosure. Computing system 110 broadly represents any single or multi-processor computing device or system capable of executing computer-readable instructions. Examples of computing system 110 include, without limitation, workstations, laptops, client-side terminals, servers, distributed computing systems, handheld devices, or any other computing system or device. In its most basic configuration, computing system 110 may include at least one processor 114 and a system memory 116.

Processor 114 generally represents any type or form of processing unit capable of processing data or interpreting and executing instructions. In certain embodiments, processor 114 may receive instructions from a software application or module. These instructions may cause processor 114 to perform the functions of one or more of the example embodiments described and/or illustrated herein.

System memory 116 generally represents any type or form of volatile or non-volatile storage device or medium capable of storing data and/or other computer-readable instructions. Examples of system memory 116 include, without limitation, RAM, ROM, flash memory, or any other suitable memory device. Although not required, in certain embodiments computing system 110 may include both a volatile memory unit (such as, for example, system memory 116) and a non-volatile storage device (such as, for example, primary storage device 132).

Computing system 110 may also include one or more components or elements in addition to processor 114 and system memory 116. For example, in the embodiment of FIG. 1, computing system 110 includes a memory controller 118, an input/output (I/O) controller 120, and a communication interface 122, each of which may be interconnected via a communication infrastructure 112. Communication infrastructure 112 generally represents any type or form of infrastructure capable of facilitating communication between one or more components of a computing device. Examples of communication infrastructure 112 include, without limitation, a communication bus (such as an Industry Standard Architecture (ISA), Peripheral Component Interconnect (PCI), PCI Express (PCIe), or similar bus) and a network.

Memory controller 118 generally represents any type or form of device capable of handling memory or data or controlling communication between one or more components of computing system 110. For example, memory controller 118 may control communication between processor 114, system memory 116, and I/O controller 120 via communication infrastructure 112.

I/O controller 120 generally represents any type or form of module capable of coordinating and/or controlling the input and output functions of a computing device. For example, I/O controller 120 may control or facilitate transfer of data between one or more elements of computing system 110, such as processor 114, system memory 116, communication interface 122, display adapter 126, input interface 130, and storage interface 134.

Communication interface 122 broadly represents any type or form of communication device or adapter capable of facilitating communication between example computing system 110 and one or more additional devices. For example, communication interface 122 may facilitate communication between computing system 110 and a private or public network including additional computing systems. Examples of communication interface 122 include, without limitation, a wired network interface (such as a network interface card), a wireless network interface (such as a wireless network interface card), a modem, and any other suitable interface. In one embodiment, communication interface 122 provides a direct connection to a remote server via a direct link to a network, such as the Internet. Communication interface 122 may also indirectly provide such a connection through any other suitable connection.

Communication interface 122 may also represent a host adapter configured to facilitate communication between computing system 110 and one or more additional network or storage devices via an external bus or communications channel. Examples of host adapters include, without limitation, Small Computer System Interface (SCSI) host adapters, Universal Serial Bus (USB) host adapters, IEEE (Institute of Electrical and Electronics Engineers) 1394 host adapters, Serial Advanced Technology Attachment (SATA) and External SATA (eSATA) host adapters, Advanced Technology Attachment (ATA) and Parallel ATA (PATA) host adapters, Fibre Channel interface adapters, Ethernet adapters, or the like. Communication interface 122 may also allow computing system 110 to engage in distributed or remote computing. For example, communication interface 122 may receive instructions from a remote device or send instructions to a remote device for execution.

As illustrated in FIG. 1, computing system 110 may also include at least one display device 124 coupled to communication infrastructure 112 via a display adapter 126. Display device 124 generally represents any type or form of device capable of visually displaying information forwarded by display adapter 126. Similarly, display adapter 126 generally represents any type or form of device configured to forward graphics, text, and other data for display on display device 124.

As illustrated in FIG. 1, computing system 110 may also include at least one input device 128 coupled to communication infrastructure 112 via an input interface 130. Input device 128 generally represents any type or form of input device capable of providing input, either computer- or human-generated, to computing system 110. Examples of input device 128 include, without limitation, a keyboard, a pointing device, a speech recognition device, or any other input device.

As illustrated in FIG. 1, computing system 110 may also include a primary storage device 132 and a backup storage device 133 coupled to communication infrastructure 112 via a storage interface 134. Storage devices 132 and 133 generally represent any type or form of storage device or medium capable of storing data and/or other computer-readable instructions. For example, storage devices 132 and 133 may be a magnetic disk drive (e.g., a so-called hard drive), a floppy disk drive, a magnetic tape drive, an optical disk drive, a flash drive, or the like. Storage interface 134 generally represents any type or form of interface or device for transferring data between storage devices 132 and 133 and other components of computing system 110.

In one example, databases 140 may be stored in primary storage device 132. Databases 140 may represent portions of a single database or computing device or it may represent multiple databases or computing devices. For example, databases 140 may represent (be stored on) a portion of computing system 110 and/or portions of example network architecture 200 in FIG. 2 (below). Alternatively, databases 140 may represent (be stored on) one or more physically separate devices capable of being accessed by a computing device, such as computing system 110 and/or portions of network architecture 200.

Continuing with reference to FIG. 1, storage devices 132 and 133 may be configured to read from and/or write to a removable storage unit configured to store computer software, data, or other computer-readable information. Examples of suitable removable storage units include, without limitation, a floppy disk, a magnetic tape, an optical disk, a flash memory device, or the like. Storage devices 132 and 133 may also include other similar structures or devices for allowing computer software, data, or other computer-readable instructions to be loaded into computing system 110. For example, storage devices 132 and 133 may be configured to read and write software, data, or other computer-readable information. Storage devices 132 and 133 may also be a part of computing system 110 or may be separate devices accessed through other interface systems.

Many other devices or subsystems may be connected to computing system 110. Conversely, all of the components and devices illustrated in FIG. 1 need not be present to practice the embodiments described herein. The devices and subsystems referenced above may also be interconnected in different ways from that shown in FIG. 1. Computing system 110 may also employ any number of software, firmware, and/or hardware configurations. For example, the example embodiments disclosed herein may be encoded as a computer program (also referred to as computer software, software applications, computer-readable instructions, or computer control logic) on a computer-readable medium.

The computer-readable medium containing the computer program may be loaded into computing system 110. All or a portion of the computer program stored on the computer-readable medium may then be stored in system memory 116 and/or various portions of storage devices 132 and 133. When executed by processor 114, a computer program loaded into computing system 110 may cause processor 114 to perform and/or be a means for performing the functions of the example embodiments described and/or illustrated herein. Additionally or alternatively, the example embodiments described and/or illustrated herein may be implemented in firmware and/or hardware.

For example, a computer program for implementing the CID solution of the present invention may be stored on the computer-readable medium and then stored in system memory 116 and/or various portions of storage devices 132 and 133. When executed by the processor 114, the computer program may cause the processor 114 to perform and/or be a means for performing the functions required for carrying out the CID procedure discussed in further detail below.

### Cutter in Diagnosis (CID)—a Method to Improve the Throughput of the Yield Ramp Up Process

Diagnosis of failing IC devices is critical for providing valuable information regarding the location and types of defects occurring in the ICs during the manufacturing process. Statistical yield analysis is conducted using the diagnostic data to effectively identify dominant defect patterns within the ICs and, consequently, improve the yield ramp up process.

As discussed above, the speed of the yield ramp up process is critical to the time-to-market metric in the semiconductor industry. Determining the root cause of the failing behavior in the IC is the critical task in the yield ramp up process. However, conventional software based root causing methodologies tend to be extremely slow and resource intensive for large designs. For example, for a large design with millions of gates, a diagnostic tool can require up to hundreds of gigabytes of memory.

Further, as the gate count per chip continues to increase, conventional root causing methodologies become increasingly impractical due to the significant processing and memory resources needed to simulate large designs with high gate counts. For example, in any manufacturing environment, such as a foundry, there may be thousands of failing devices that may need to be diagnosed within a few days with limited computational resources. Given the computational and time constraints, conventional root causing technologies are increasingly unable to support diagnosis of such a high volume of failing devices. Due to current run time limitations, in fact, IC developers typically only run selected chips through the software based root causing diagnostic procedures. This increases the chance of missing out on some defect profiles.

Embodiments of the present invention, therefore, provide solutions to the challenges inherent in speeding the yield ramp up process. One embodiment of the present invention intelligently determines and carves out the logic affected by the defect (referred to herein as the “failing block”) from the entire design of the chip and creates a smaller design. Subsequently, the software simulations are run on the smaller design in order to isolate the defect location. This procedure taught by the present invention is referred to as “Cutter In Diagnosis” (CID). The CID procedure increases the throughput of volume diagnosis by increasing the number of defective dies that can be tested during a given period of time. Further, the CID procedure uses significantly fewer processing and memory resources relative to conventional root causing methods. Accordingly, the CID tool speeds up the yield ramp up process by performing simulation and diagnosis of defective dies at a rapid rate using considerably fewer resources.

FIG. 2 is a schematic block diagram for an automated test equipment (ATE) apparatus used to test semiconductor IC chips. The ATE apparatus 200 may be used, for example, during the manufacturing process at a foundry, to initially determine which of the devices are failing. In one embodiment, the system controller 201 comprises one or more linked computers. In other embodiments, the system controller can comprise only a single computer. The system controller 201 is the overall system control unit, and runs the software for the ATE that is responsible for accomplishing all the user-level testing tasks, including running the user's main test program. The test program may comprise the functional and other necessary tests needed to validate the connected devices under test (DUTs). In one embodiment, the DUTs can be semiconductor IC devices.

The communicator bus 215 provides a high-speed electronic communication channel between the system controller and the tester hardware. The communicator bus can also be referred to as a backplane, a module connection enabler, or system bus. Physically, communicator bus 215 is a fast, high-bandwidth duplex connection bus that can be electrical, optical, etc. System controller 201 sets up the conditions for testing the DUTs 211-214 by programming the tester hardware through commands sent over the communicator bus 215.

Tester hardware 202 comprises the complex set of electronic and electrical parts and connectors necessary to provide the test stimulus (test vectors) to the devices under test (DUTs) 211-214 and measure the response of the DUTs to the stimulus, and compare it against the expected response.

After probe testing is performed by the ATE apparatus 200, the failing outputs of the tested ICs are determined Diagnostic procedures can then be run in software to root cause the failing behavior.

FIG. 3 illustrates an electron microscope image showing an exemplary open defect on metal. An open defect is an example of one type of manufacturing defect that results in the failing behavior, which can be root caused in software using the CID procedure of the present invention. An open defect on line 310 exists because line 310 was accidentally broken during the manufacturing process as shown in FIG. 3. Other types of manufacturing defects besides open circuits (breaks) that may result in failing behavior are short circuits (bridges) or via-blocks. In one embodiment of the present invention, the critical area or failing block comprising logic gates and nets affected by any such defect is carved out of the entire design using the CID tool and diagnostic procedures are run on the carved out portion of the design, instead of the entire design, to attempt to isolate the defect location.

FIG. 4 illustrates an exemplary failing block in the chip design comprising the logic affected by the defect that can be carved out using the CID tool in accordance with one embodiment of the present invention. Chip design 400, illustrated in FIG. 4, can, for example, comprise an ARM core module 450, two processor data path modules, 430 and 440, a digital logic block module 420, an I/O module 470, a video DAC module 497, a WiFi module 495, an audio module 496, a USB module 460, a PLL module 480 and a DDR SDRM interface module 490.

In one embodiment of the present invention, instead of simulating the entire chip design 400, the CID procedure acts as a mapper and extracts a failing block 410 associated with a defect in software during the diagnostic process. It then simulates the smaller design associated with the failing 410 instead. However, before the extraction of failing block 410, the CID tool first needs to determine a set of suspect fault candidates associated with the defect that comprises the failing block 410. Stated differently, the CID tool first needs to determine the logic gates and nets that comprise the failing block before extracting it from the design and simulating it as a discrete module.

FIG. 5A is a block diagram illustrating an exemplary process flow for a general diagnostic procedure used to cull the list of candidate suspects to determine a failing block in the chip design in accordance with one embodiment of the present invention. Starting with the failing primary outputs observed by probing the outputs of an IC chip following the manufacturing process, the CID procedure uses critical path tracing or “back tracing” through the circuit represented in software at block 501 to identify a set of suspect fault candidates that could potentially result in the observed faulty behavior of the IC. A path is considered critical if its change causes the output of any failing observation points to change. Critical path tracing comprises simulating the fault-free circuit and using the computed signal values to trace the path from the observed failing primary outputs towards the primary inputs feeding those outputs to determine a primary list of suspect fault candidates for the detected fault at block 502.

At block 503, forward path tracing is used to cull the list of suspects down even further and narrow the size of the failing block used by the CID tool. In one embodiment, the initial suspect candidates determined at block 502 can be injected with various input stimuli and the outputs forward traced to determine whether the behavior at the failing observation points replicates the behavior observed during the probing of the ICs. For example, a suspect candidate can be injected with an input pattern that is known to have produced failing results at one of the failing primary outputs. The response at the failing output during the simulation is matched against the observed response at the failing output during probing of the defective die. If the response does not match, the suspect candidate can be removed from the list of suspected fault candidates. Similarly, a suspect candidate can also be injected with an input pattern that is known to have produced passing results at one of the failing primary outputs. If the suspect candidate produces failing results during simulation for this input pattern, it also can be culled out of the suspect candidate list. In this way forward tracing can be used to determine a narrower secondary suspect fault list at block 504, thereby, enabling the CID tool to attain better accuracy and resolution. Together, the critical path or back tracing and forward tracing reduce the search space and enable the CID tool to extract a design space much smaller than the original design to be simulated.

The secondary suspect fault list is then used to simulate the failing block to determine candidate fault circuitry corresponding to the defect. The candidate fault circuitry can subsequently be transmitted to a foundry where the physical die associated with the IC design can be physically inspected at locations corresponding to the candidate fault circuitry in order to isolate the root cause of the defect. Once the defect is isolated, then process changes can be put into place in the fabrication process to address the defect. By rapidly being able to provide candidate lists for defects, the time to discover a defect decreases and the number of defects that can be detected in an allotted period of time rises. Accordingly, the yield can be improved and the speed of the yield ramp up process can be significantly increased.

The processing and memory requirements to perform the above described initial simulation of the fault-free circuit initially and to conduct both back and forward tracing can be high. However, an advantage of the CID tool of the present invention is that it does not have the large processing or memory requirements associated with simulating the entire circuit during diagnosis or saving extraneous information such as simulation status of all the nodes in the circuit that are not related to the root cause of failure. Conventional methods of root causing are comparatively much slower because simulating and diagnosing the entire design requires maintaining the statuses of the millions of gates and nets comprising the design simultaneously in memory.

Accordingly, using the CID tool greatly enhances the throughput for diagnosing larger designs. For example, in certain cases, using the CID tool can result in more than a 70,000× improvement in the turnaround time of the software based root causing techniques. Further, this magnitude of improvement will only increase as device sizes keep getting larger. The amount of area affected by a particle defect remains constant but the number of cells affected by the particle defect may increase because of the shrinking technology nodes. But this increase is expected to be very small. Thus, the amount of logic that the CID tool needs to carve out will increase very slowly and, typically, will not be more than 1% of the entire design size. Thus, using the CID tool results in a huge performance gain with respect to conventional root causing software (which simulates the entire design) even for future design sizes.

Another advantage of the faster simulation times and small designs of the present invention is that several other software based root causing methods that were formerly considered too difficult to run due to design size can be used in conjunction with the present invention. The yield ramp up process will consequently be more accurate and fast if there are more effective defect isolation methods available to use.

Finally, because of the processing and memory constraints of conventional diagnostic methods, only selected chips are run through the software based root causing procedures. This increases the chances of overlooking some defect mechanisms. With the CID approach of the present invention, chip developers or manufacturers will likely have full capacity to run all the failing chips through the root causing software and catch many more failure mechanisms in both the bring-up stage and volume production.

FIG. 5B is a block diagram illustrating the diagnostic partitioning used to determine the failing blocks associated with failing outputs in accordance with one embodiment of the present invention. IC 500 comprises inputs 540A-540N and outputs 530A-530E. During the probing process undertaken following the manufacturing process, IC 500 may have been found to comprise two failing outputs, 530B and 530C.

After failing outputs 530B and 530C are identified through probing, software-based root causing methods of the present invention can be used to trace backwards to identify a set of suspect fault candidates comprising gates and nets that could potentially result in the observed faulty behavior of the IC. This set of suspect fault candidates eventually comprises the failing block operated on by the CID tool of the present invention, as discussed above.

Using back tracing, first the fan-in cones for each of the failing outputs 530B and 530C can be determined. Typically, the fan-in cone for any given failing output comprises the logic paths that can structurally reach the failing output. The fan-in cone for failing output 530B is represented by area 580 and the fan-in cone for failing output 530C is represented by area 590. Back tracing to determine fan-in cones enables the CID procedure of the present invention to determine an initial list of fault candidates. The defect can be expected to lie somewhere within the area covered by the combined union of fan-in cones 580 and 590.

Next forward tracing is used to further narrow the list of possible suspects. One or more of suspect candidates within the fan-in cones 580 and 590, in one embodiment, can first be injected with an input pattern that is known to have produced failing results at one of the failing primary outputs, 530B or 530C. If the resulting response does not match the observed response, as explained above, the suspect candidate can be removed from list of suspects. Subsequently, one or more suspect candidates can also be injected with an input pattern that is known to have produced passing results at one of the failing primary outputs. If the suspect candidate produces failing results during simulation for this input pattern, it also can be culled out of the suspect candidate list. In one embodiment, the passing input pattern can be run before the failing input pattern during the forward tracing process.

The result of the back and forward tracing is one or more failing blocks, 505 and 510, that can be extracted by the CID tool and simulated independent of the design of the entire chip.

As discussed above, the failing block(s) can be simulated to determine candidate fault circuitry corresponding to the defect(s). The candidate fault circuitry can subsequently be transmitted to a foundry where the physical die associated with the IC design can be physically inspected at locations corresponding to the candidate fault circuitry in order to isolate the root cause of the defect.

In one embodiment, the resolution of the CID tool can be improved by observing the output at additional passing primary outputs as well. For example, a suspect within fan-in cone 580 can pass both the passing input pattern test and failing input pattern test of the forward tracing procedure if only outputs 530B and 530C are being observed. However, the same suspect may produce a failing result at output 530A. Therefore, in one embodiment, the fan-in cone of passing primary output 530A may also be included in the analysis to further reduce the list of suspects, thereby, improving resolution. However, this would increase the size of the failing block and, consequently, require more processing and memory resources. There is, therefore, a tradeoff between the number of observational nodes used to determine the suspect list and the resulting size of the failing block.

In another embodiment, a limit can be set on the size of the failing block that is simulated independent of the broader circuit. For example, the CID tool may set an upper bound on the failing block to be 10% of the total gates in the original circuit. If the size of the failing block determined using the back and forward tracing techniques winds up being over 10%, the CID tool will drop fan-in cones associated with primary passing outputs until the size of the failing block drops below 10%. Similarly, if the size of the failing block ends up being much below 10%, the CID tool can add additional observational nodes to the partition to improve resolution.

FIG. 6 is a block diagram illustrating an exemplary process flow for troubleshooting a defected IC, determining the root cause of failure using the CID tool, and improving yield in accordance with one embodiment of the present invention.

Block 610 represents the die to be tested following the manufacturing process at the foundry. At block 620, a tester similar to tester 200 in FIG. 2 can be used to probe the die to determine the failing primary outputs. A test log is generated at block 630, which comprises information regarding the expected outputs and the actual outputs resulting from testing die 610. In one embodiment, only the failing bits are logged within the test log file, so that the failing bits (or failing outputs) can be easily determined. The test log can be used by the designer of the chip to trouble-shoot failures in the chip using root causing software methodologies.

At block 640, the diagnosis program comprising the CID tool of the present invention is used as described above to identify a list of suspect fault candidates for the defect in the die.

First, back and forward tracing is used, as discussed above, and, subsequently, a suspected failing block associated with the fault candidates is identified. This failing block is significantly smaller than the original design and can be simulated and diagnosed much faster with considerably fewer resources. The result of the failing block simulation provides the logic cells suspected of causing device failure. As shown in FIG. 6, this process is repeated with all the dies comprising the same design in a given batch.

The candidate fault circuitry is provided back to the manufacturers of the device 610 so that the physical location corresponding to the suspected logic cells can be inspected for any material defects, e.g., bridging faults at block 660. As illustrated in the figure, physical inspection is undertaken for all the dies to determine the defect locations within the die.

In one embodiment, a fault histogram can be used at block 670 to determine the most commonly occurring or problematic defects in the fabrication process.

At block 680, the fabrication process can be adjusted to cure for the defects. As a result, yield can be improved at block 690. Also, because of the short simulation times required to simulate the identified failing blocks, yield ramp up times are decreased.

FIG. 7 depicts a flowchart 640 of an exemplary process of identifying candidate fault circuitry using the CID procedures according to an embodiment of the present invention. Flowchart 640 provides a more detailed view of how logic cells suspected of causing failure are identified in software at block 640 of FIG. 6. The invention, however, is not limited to the description provided by flowchart 640. Rather, it will be apparent to persons skilled in the relevant art(s) from the teachings provided herein that other functional flows are within the scope and spirit of the present invention. Flowchart 640 will be described with continued reference to exemplary embodiments described above, though the method is not limited to those embodiments.

At block 702, the failing primary outputs are from probing the physical die are received from the foundry. As discussed previously, the test log file generated from the probing comprises the list of actual and expected outputs that can be used by the root causing software of the present invention to read in the list of failing primary outputs.

At block 704, root causing software that comprises the CID tool can simulate the fault-free original design of the circuit in software during a preprocessing stage. The simulation values extracted during this preprocessing stage are then later used for the back and forward tracing performed by the CID tool in accordance with an embodiment of the present invention. While this simulation can be time and resource intensive, the cost is negligible compared to the time and resource cost of diagnosing the several thousand or more dies that may be associated with the design being simulated during the yield ramp up process.

At block 706, the CID procedure uses critical path tracing or “back tracing” to identify fan-in cones associated with each failing primary output using the signal values determined from the fault-free circuit simulation. Using the fan-in cones, the CID procedure can then determine the initial list of suspect fault candidates that could potentially result in the observed faulty behavior of the IC at block 708.

At block 710, the CID procedure uses forward path tracing to cull the list of suspects down even further. As describe above, forward path tracing can involve injecting suspect candidates with both passing and failing input stimuli and determining if the behavior of the failing outputs conforms with the behavior of the same outputs observed during the probing process.

Once the secondary list of suspect candidates is determined, the failing block is identified using the CID procedure at block 712 and simulated independently of the original design to determine a final list of suspect candidates potentially associated with the defect in the die. These are the candidates that are then transmitted back to the foundry and used to diagnose the defect location in the die.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface. Various functions described herein may be provided through a remote desktop environment or any other cloud-based computing environment.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

Embodiments according to the invention are thus described. While the present disclosure has been described in particular embodiments, it should be appreciated that the invention should not be construed as limited by such embodiments, but rather construed according to the below claims.

What is claimed is:

1. A method for producing candidate fault circuitry in an integrated circuit, said method comprising:
tracing back from at least one failing output of said integrated circuit to determine a corresponding fan-in cone for each failing output using simulation values obtained from a fault free simulation of a design of said integrated circuit;
determining a first set of suspect fault candidates for said each failing output, wherein each suspect fault candidate potentially corresponds to a defect in said integrated circuit responsible for producing a failing result at a corresponding failing output;
tracing forward from each suspect fault candidate in said first set to determine a second set of suspect fault candidates, wherein said second set is a narrower subset of said first set, and wherein each suspect fault candidate in said second set has a higher likelihood of corresponding to a defect in said integrated circuit than each suspect fault candidate in said first set; and
identifying a failing block from said design of said integrated circuit, wherein said failing block comprises suspect fault candidates from said second set, and wherein said failing block can be simulated independently of said design.

2. The method of claim 1, further comprising simulating said failing block to determine a third set of suspect fault candidates, wherein said third set is a narrower subset of said second set, and wherein each suspect fault candidate in said third set has a higher likelihood of corresponding to a defect in said integrated circuit than each suspect fault candidate in said second set.

3. The method of claim 1, wherein a type of defect in said integrated circuit can be selected from the group comprising: a bridge, a break and a via-block.

4. The method of claim 1, wherein said tracing forward further comprises:
entering an input stimulus into each suspect fault candidate in said first set and monitoring a response to said stimulus;
comparing said response with an observed response of a die associated with said integrated circuit to said input stimulus, wherein said observed response is recorded during hardware testing and probing of said die; and
responsive to a determination that said response mismatches said observed response from said hardware testing, excluding a suspect fault candidate from said second set.

5. The method of claim 4, wherein said tracing forward further comprises:
responsive to a determination that said response matches said observed response from said hardware testing, including a suspect fault candidate in said second set.

6. The method of claim 4, wherein said input stimulus is a failing pattern, wherein said failing pattern produces a failing response at a corresponding failing output.

7. The method of claim 4, wherein said input stimulus is a passing pattern, wherein said passing pattern produces a passing response at a corresponding failing output.

8. The method of claim 1, wherein said identifying further comprises:
incorporating suspect fault candidates from a fan-in cone of a passing primary output into said failing block.

9. The method of claim 1, wherein said failing block is subject to a size limit, wherein said size limit is expressed as a percentage of a size of said design of said integrated circuit.

10. A computer-readable storage medium having stored thereon, computer executable instructions that, if executed by a computer system cause the computer system to perform a method for producing candidate fault circuitry in integrated circuits, said method comprising
tracing back from at least one failing output of said integrated circuit to determine a corresponding fan-in cone for each failing output using simulation values obtained from a fault free simulation of a design of said integrated circuit;
determining a first set of suspect fault candidates for said each failing output, wherein each suspect fault candidate potentially corresponds to a defect in said integrated circuit responsible for producing a failing result at a corresponding failing output;
tracing forward from each suspect fault candidate in said first set to determine a second set of suspect fault candidates, wherein said second set is a narrower subset of said first set, and wherein each suspect fault candidate in said second set has a higher likelihood of corresponding to a defect in said integrated circuit than each suspect fault candidate in said first set; and
identifying a failing block from said design of said integrated circuit, wherein said failing block comprises suspect fault candidates from said second set, and wherein said failing block can be simulated independently of said design.

11. The computer-readable medium of claim 10, wherein said method further comprises simulating said failing block to determine a third set of suspect fault candidates, wherein said third set is a narrower subset of said second set, and wherein each suspect fault candidate in said third set has a higher likelihood of corresponding to a defect in said integrated circuit than each suspect fault candidate in said second set.

12. The computer-readable medium of claim 10, wherein a type of defect in said integrated circuit can be selected from the group comprising: a bridge, a break and a via-block.

13. The computer-readable medium of claim 10, wherein said tracing forward further comprises:
entering an input stimulus into each suspect fault candidate in said first set and monitoring a response to said stimulus;
comparing said response with an observed response of a die associated with said integrated circuit to said input stimulus, wherein said observed response is recorded during hardware testing and probing of said die; and
responsive to a determination that said response mismatches said observed response from said hardware testing, excluding a suspect fault candidate from said second set.

14. The computer-readable medium of claim 13, wherein said tracing forward further comprises:
responsive to a determination that said response matchers said observed response from said hardware testing, including a suspect fault candidate in said second set.

15. The computer-readable medium of claim 13, wherein said input stimulus is a failing pattern, wherein said failing pattern produces a failing response at a corresponding failing output.

16. The computer-readable medium of claim 13, wherein said input stimulus is a passing pattern, wherein said passing pattern produces a passing response at a corresponding failing output.

17. The computer-readable medium of claim 10, wherein said identifying further comprises:
incorporating suspect fault candidates from a fan-in cone of a passing primary output into said failing block.

18. The computer-readable medium of claim 10, wherein said failing block is subject to a size limit, wherein said size limit is expressed as a percentage of a size of said design of said integrated circuit.

19. A tester system comprising:
an input interface for reading in a test log, wherein said test log comprises information concerning observed responses recorded at a plurality of failing outputs during hardware testing and probing of a die;
a memory for storing a design of an integrated circuit corresponding to said die and simulation values generated from a simulation of said design of said integrated circuit; and
a processor configured to:
trace back from said plurality of failing outputs associated with said design of said integrated circuit to determine a corresponding fan-in cone for each failing output using simulation values obtained from a fault free simulation of said design of said integrated circuit;
determine a first set of suspect fault candidates for said each failing output, wherein each suspect fault candidate potentially corresponds to a defect in said integrated circuit responsible for producing a failing result at a corresponding failing output;
trace forward from each suspect fault candidate in said first set to determine a second set of suspect fault candidates, wherein said second set is a narrower subset of said first set, and wherein each suspect fault candidate in said second set has a higher likelihood of corresponding to a defect in said integrated circuit than each suspect fault candidate in said first set; and
identify a failing block from said design of said integrated circuit, wherein said failing block comprises suspect fault candidates from said second set, and wherein said failing block can be simulated independently of said design.

20. The tester system of claim 19, wherein said processor is further configured to simulate said failing block to determine a third set of suspect fault candidates, wherein said third set is a narrower subset of said second set, and wherein each suspect fault candidate in said third set has a higher likelihood of corresponding to a defect in said integrated circuit than each suspect fault candidate in said second set.
